(19) United States
(12) Patent Application Publication
(10) Pub. No.: US 2004/0249906 A1
(43) Pub. Date: Dec. 9, 2004

(54) Device discovery and configuration utilizing DHCP protocol

(75) Inventors: Eric T. Olbricht, Vancouver, WA (US); Craig T. Whittle, Vancouver, WA (US); Elliot L. Howard, Forest Grove, OR (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/391,941

(22) Filed: Mar. 19, 2003

(51) Int. Cl. G06F 15/177

(52) U.S. Cl. 709/220

(57) ABSTRACT

A method and a system employable in conjunction with a computer-based IP network of a type which includes no DHCP/BootP server, for nonetheless employing, in an unusual manner, the traditional DHCP protocol in a way which allows for (a) the discovery of yet IP-unaddressed client devices connected to the network, and further (b) for the assigning of such an address to such a discovered device. From a methodologic point of view, the invention contemplates the unsolicited and gratuitous broadcasting over the network, in response to what can be thought of as an imaginary client-device request to a network server for an IP address, of a response packet to such an imaginary request, which broadcast elicits responses from yet undiscovered client devices which will identify themselves and whether or not they possess IP addresses, thus to enable further implementation of the same DHCP standard protocol then to assign appropriate IP addresses to these devices, and thus to configure them for thereafter normal access and utility in the associated network.

### BACKGROUND AND SUMMARY OF THE INVENTION

This invention pertains to a method and apparatus which utilizes an industry standard network configuration protocol, such as the standard DHCP protocol, in a unique manner to permit the discovery, and the IP-address configuring, of new devices connected for operation in a statically assigned IP network environment of a type that does not include within it, for example, a DHCP/BootP server. The preferred embodiment of, and manner of practicing, the invention are disclosed and illustrated herein with specific reference to our discovering of how features of the standard DHCP protocol enable an unusual use of this protocol to perform both discovery and configuration of IP-address-requiring devices in a setting seemingly mismatched to DHCP protocol practice.

The invention thus proposed herein regards a newly determined use of the DHCP protocol, which protocol is normally employed in a quite different manner and in a different system and network configuration for assigning IP addresses. Very specifically, we have found that the DHCP protocol can be employed as a quite capable tool, in accordance with practice of the present invention, to assign, through any appropriate configuration application/utility, a static IP address, following the practice of a unique, DHCP-implemented discovery of a device which is in need of such an address.

By way of a brief, preliminary background, in network environments that use statically assigned IP addresses, a new device connected in such a network does not “know” what address to assign to itself. In a purely static network environment where there is no DHCP server provided to perform this task, the user/operator must either enter an IP address directly into a device, as for example via front-panel controls, or must implement some other address-assigning, and configuring, method over the network. Since such a new, added device does not have an IP address, standard network protocols cannot be employed for this purpose. Instead, a proprietary protocol may be used, which protocol typically cannot be routed, and is therefore limited effectively to local sub-networks.

The present invention directly addresses this problem. It does so by proposing, as suggested above, a unique mode for use of the otherwise standard DHCP protocol in such a non-DHCP-server-active network, wherein new devices, such as printers or MFPs, may be connected that do not have assigned IP addresses initially, though they are otherwise IP-compatible devices. The manner in which this unique usage of the standard and well understood DHCP protocol takes place is now set forth in the detailed description below.

A document available in the prior art literature which may be quite helpful to review in conjunction with practicing the present invention, in environments where no other configuration mechanism, like DHCP, is available, is Internet Draft http://files.zeroconf.org/draft-ietf-zeroconf-ipv4-linklocal.txt. As a matter of convenience to those now reading this invention disclosure, a full copy of that Internet Draft text is attached hereto as Appendix A, paginated internally separately.

The various features and advantages which are offered and attained by the present invention will become more fully apparent as the description which now follows is read in conjunction with the accompanying drawings.

### DESCRIPTION OF THE DRAWINGS

FIG. 1 is a simplified block/schematic illustration of a non-DHCP-server computer-based network including a device which functions as a Host therein in accordance with practice of the present invention, along with several devices, such as printers, copiers, scanners or MFP devices, at least some of which, while IP-ready and capable, do not yet have respective assigned IP addresses in the network.

FIG. 2 is a block and process-flow diagram which can be read to describe and understand both the systemic and the methodologic aspects of the present invention.

FIGS. 3 and 4 illustrate user interfaces that are presented on the screen, for example, of the Host computer device included in the network of FIG. 1, which interfaces appear generally during practice of the present invention at the “locations” in that practice illustrated and marked generally in FIG. 2 in the drawings. Very specifically, FIG. 3 illustrates a user interface that provides a discovered-device report which presents, as will be explained, a filtered list of devices present in a network, such as the network pictured in FIG. 1, with those devices which do not currently have assigned IP addresses clearly indicated in this report list. FIG. 4 illustrates a configuration user-interface which, upon selection, from a list like that shown in FIG. 3, of a device to configure, may then be employed, through conventional virtual controls presented on the screen of the displaying device, effectively to utilize the DHCP protocol (which has been invoked in accordance with practice of the present invention) to configure the selected device.

### DETAILED DESCRIPTION OF THE INVENTION

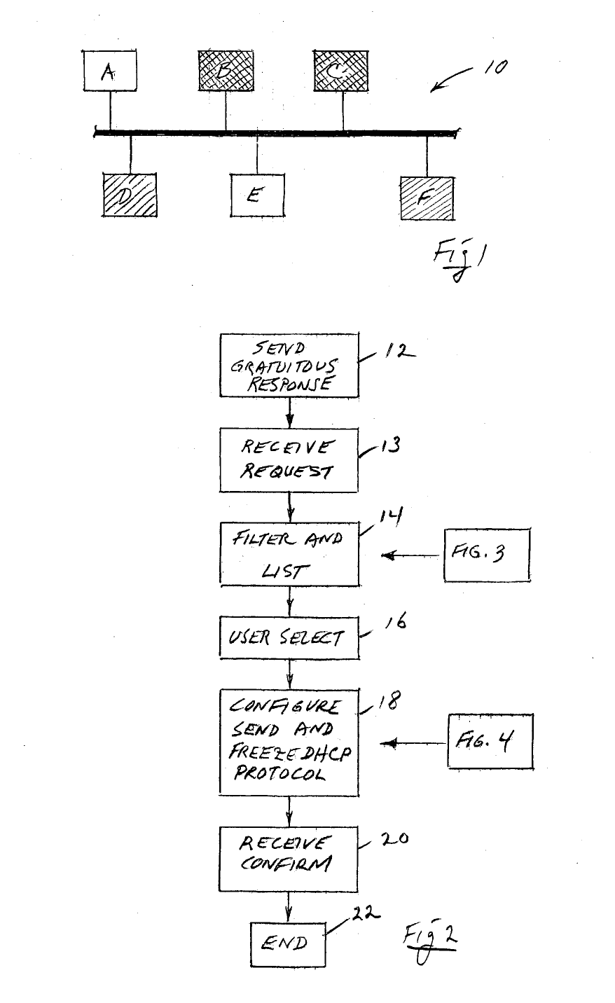

Turning now to the drawings, and referring first of all to FIG. 1, indicated generally at 10 is a non-DHCP-server, computer-based network to which six devices, labeled A, B, C, D, E and F, are connected. Device E, herein is a typical user workstation which is designated in the setting pictured in FIG. 1 as what is referred to herein as the Host. Devices A, B, C, D, and F are printers, copiers, scanners or MFP devices, and among these five devices, devices B, C, D and F are each of an appropriate type for configuration access, in accordance with the practice of the invention, and this is indicated by the presence of shading in the respective blocks in FIG. 1 which represent them. As can be seen, the shading which is employed in blocks B and C differs from that used in blocks D and F. This is done to indicate that the devices represented by blocks B and C do not currently have assigned IP addresses, whereas those represented by blocks D and F do have such addresses.

Looking at FIGS. 2-4, inclusive, along with FIG. 1, Host E is suitably “armed” or equipped, in accordance with the invention, to broadcast over the network, selectively and, for example, at the call of a user, or when it is first (or each time) turned on, what constitutes a relatively conventional DHCP, but gratuitous, or unsolicited, response packet. Those skilled in the art understand fully what such a packet consists of, and recognize that such a packet is ordinarily broadcast not unsolicited, but rather at the instance of an incoming client request from a new device seeking an IP address. In network 10, however, with respect to devices B and C which do not yet have assigned IP addresses, and inasmuch as network 10 does not include a DHCP server, these devices do not initiate such a client request.

This unsolicited response-packet broadcast represents a key component of the present invention, in the general sense that it effectively bypasses, or ignores, the lack of a network DHCP server, by acting as if on the occurrence of a “ghost” or “phantom” client-device address request. An early important step in the practice of the invention, therefore, is, in effect, a step to create an environment wherein a device, which is equipped, but not as a dedicated DHCP server, to deliver a network-configuration-protocol-like response to a “phantom” client-device address-request delivers such an unsolicited response.

Such a response is reacted to by various pre-selected (filtered) categories of devices, including devices in these categories which are yet IP-unaddressed devices. These devices' reactions will produce, in accordance with the invention, listable identities of the reacting devices per se. Thus, the unsolicited response triggers a kind of identity-reporting event which effects the important “discovery” of devices present in the network. This identity-reporting event will also include a reporting-device-by-reporting-device “accounting” of the existence, and if any the identity, of an assigned IP address. A reporting device lacking an assigned IP address will so indicate.

It is therefore this unsolicited invocation of the otherwise traditional DHCP protocol, in what is an unusual and almost reverse-like fashion, to supply a gratuitous response packet as an initiating step, that enables use of the DHCP protocol, in accordance with practice of the present invention, to effect discovery on network 10 of the presence of devices B and C which do not currently have assigned IP addresses.

In FIG. 2 in the drawings, this invocation of the DHCP protocol to initiate such a gratuitous response packet broadcast over the network is represented by block 12. Block 13 in this figure represents responsive device requests for IP addresses that have been triggered by the gratuitous response packet which was broadcast as represented by block 12. Block 13 can also be viewed as representing all network device reactions which result.

Further, and still according to a preferred manner of practicing the invention, Host device E, in addition to being thus armed to implement the DHCP protocol, is further armed selectively both to filter and to list responses that become solicited by the broadcast gratuitous response packet sent out by the DHCP protocol. Such filtration and listing, which can be conducted in any one of a number of different conventional manners, may be desirable in order to permit, as noteworthy incoming responses, only those responses which come from certain types, categories or makes of printers, MFPs, etc. devices on network 10. Block 14 in FIG. 2 represents both this filtration and listing process, and the appropriate structure within Host E which performs filtration.

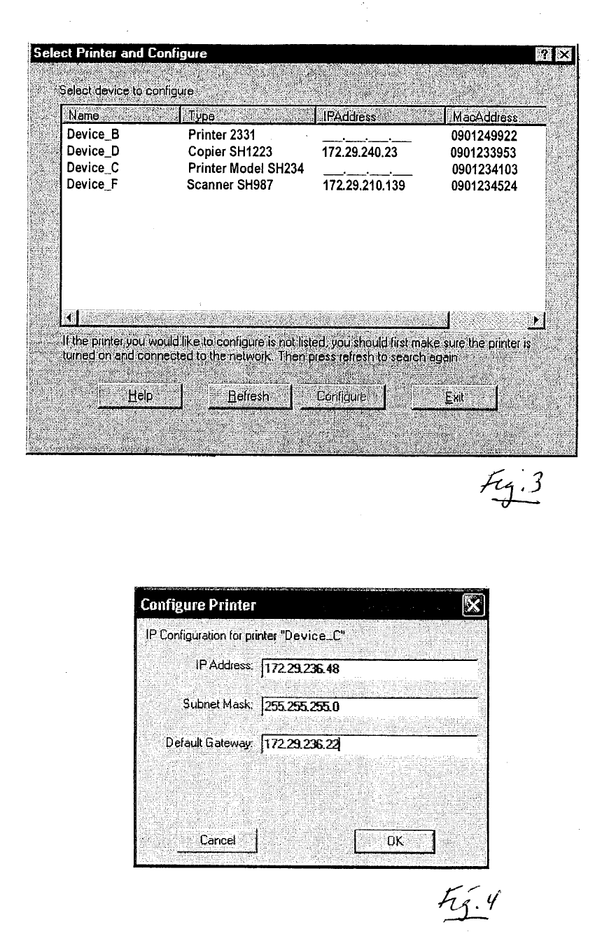

As a consequence of the unsolicited and gratuitous response packet transmitted by Host E (block 12), and further in accordance with whatever filtration has been conducted, the user is presented with a user-interface on the display screen in workstation E which looks preferably very much like what is pictured in FIG. 3 in the drawings, which figure illustrates an interface entitled “Select Printer and Configure”. In the context of network 10, as illustrated and described with respect to FIG. 1, let us simply assume for discussion purposes here that filtration has been conducted, whereby the only “determined-to-be-noteworthy” responses that will be seen in a presentation such as that pictured in FIG. 3 will be responses received from devices B, C, D and F—all of the “shaded-block”-pictured devices. A response from device A will have been “filtered out”. The relationship which exists between block 14 and FIG. 3 is generally indicated in FIG. 2 by the left-pointing arrow which extends toward block 14 from the block in FIG. 2 which is marked FIG. 3.

One can see in FIG. 3 that what has thus been presented to the user is in fact a discovery list of “filtered” devices on the network which have responded to the gratuitous DHCP response packet. These filter-passed device responses identify the respective devices, along with a number of different device-specific characteristics, including whether or not the respective devices each currently possesses an IP address. For example, in FIG. 3, of the four pictured responding devices, two (B and C) are seen to be currently lacking an IP address.

What next occurs, according to practice of the invention, is that a user, from the virtual controls provided via a user interface like what is shown in FIG. 3, initially selects a particular, yet IP-unaddressed device for configuration with an assigned IP address, in accordance with continued utilization of the just-earlier-invoked DHCP protocol. This activity of user selection is represented by block 16 in FIG. 2.

A user then selects a reporting, but yet un-IP-addressed, device, such as either of devices B or C in network 10, for configuration, whereupon, in accordance with further implementation of the invoked DHCP protocol, the user is presented with a user-interface very much like that which is shown in FIG. 4, and which is labeled “Configure Printer”. FIG. 4 illustrates a situation where the user has selected device C. It should be understood that while the specifically illustrated user-interface uses the word “Printer”, it could just as well use any other designator, such as “MFP Device”, etc. The location of the “appearance” of the interface shown in FIG. 4 in the flow of practice illustrated in FIG. 2 is represented at the location in FIG. 2 where a block marked FIG. 4 has an arrow pointing to the left toward the main flow of activity.

With an interface available to the user, such as the interface shown in FIG. 4, the user selects and enters an appropriate IP address, clicks “OK”, and under the control of Host workstation E, and the invoked DHCP protocol, the selected device, device C in the illustration now being given, is appropriately configured with the selected and identified IP address. This activity of configuring with an IP address is represented by block 18 in FIG. 2.

Another feature of the present invention is also illustrated in and performed by the activity that is represented by block 18, and namely that, with sending out of configuration information to the particular device which has been selected for configuring, DHCP protocol activity, at least with respect to that device, is disengaged, or frozen, so that the newly given and assigned IP address is effectively locked to that device. If no other IP address-assignment activity is now to take place, then, effectively, activity of the invoked DHCP protocol is entirely brought to a halt, whereafter it resides in a state of ready dormancy so-to-speak within host E.

Following IP address configuring of a device as just described, that device provides a confirmation report, see block 20, and assuming that that confirmation is correct, the entire current process with respect to that newly configured device is brought to an end, as indicated by block 22.

In terms of thinking about the systemic or structural aspects of the present invention, the methodology which has just been described above is performed by structure which is referred to herein as residing within Host device E. This structure includes: (a) first structure (block 12) operable to broadcast over the network an unsolicited DHCP response packet; (b) second structure (blocks 13, 14 and the illustration of FIG. 3) constructed to receive, and to report in a device list, return responses received (possibly filtered), on account of such a DHCP broadcast, from one or more IP-unaddressed devices; (c) third structure (what is shown on FIG. 3, along with block 16) enabling user selection from the device list of a particular IP-unaddressed device to configure with an assigned IP address; and (d) fourth structure (block 18) which is operable to effect the earlier-mentioned configuring and assigning activities. Block 18 also represents structure referred to herein as fifth structure which is constructed, in relation to the assigning and configuring activities that are performed, to disable the current operating status of the DHCP protocol, at least with respect to the device which has just been configured with an assigned IP address.

In addition to the above-described ways of viewing both the structural and methodological characteristics and features of the present invention, yet another way of viewing the methodology offered by the present invention is to see it as: a method employable in a computer-based network for discovering client devices that are connected to the network, with this method including the steps of (a) broadcasting over the network a gratuitous and unsolicited response to an imaginary client-device request to a network server for server attention, (b) by such broadcasting, eliciting responses from yet undiscovered client devices that are connected to the network, and (c) by the combination of such broadcasting and eliciting-of-responses activities, discovering theretofore undiscovered network-connected client devices.

Accordingly, a preferred manner of practicing, and a preferred structural arrangement for so practicing, a preferred and best mode embodiment and implementation of the present invention have been described and illustrated herein. While this has been done, and certain disclosure comments have been made herein, with respect to other ways of envisioning practice of the present invention, we recognize that there are certainly still other variations and modifications of the invention which may be employed, and which will come into the mind and the attention of those generally skilled in the relevant art. All of such variations and modifications are considered to be within the scope of the present invention.

We claim:

1. A method employable in a computer-based IP network which includes no DHCP/BootP server, for nonetheless employing the DHCP protocol to discover a yet IP-unaddressed device connected to the network, and to assign such an address to that device comprising
from a selected host device connected to the network selectively activating a DHCP protocol, and broadcasting an unsolicited DHCP response packet over the network,
receiving a response in the form of a client request for an IP address from one or more such IP-unaddressed devices,
selecting from that response a particular IP-unaddressed device to configure with an assigned IP address, and
after said selecting, so assigning and configuring that selected device.

2. The method of claim 1, wherein receiving of a response includes performing a filtering function whereby only pre-selected categories of responding devices will be included for selection in the subsequent selecting step.

3. The method of claim 1 which further includes, in association with the assigning and configuring step, deactivating the earlier-activated DHCP protocol.

4. A method useable in conjunction with a computer-based network for discovering and configurationally assigning an IP address to an IP-unaddressed, but IP-capable, device connected to the network comprising
invoking a DHCP protocol in a manner which is effective to discover any such device, and
upon discovering such a device, further utilizing the invoked DHCP protocol selectively to configure the discovered device with an IP address.

5. The method of claim 4, wherein the manner of invoking the DHCP protocol for the purpose of discovering such a device involves broadcasting over the network an unsolicited DHCP response packet.

6. The method of claim 4 which further includes, in conjunction with configuring a discovered device with an IP address, thereafter deactivating the earlier invoked DHCP protocol.

7. A method employable in a computer-based IP network which includes no DHCP/BootP server, for nonetheless employing the DHCP protocol to discover a yet IP-unaddressed device connected to the network comprising
from a selected host device connected to the network selectively activating a DHCP protocol, and broadcasting an unsolicited DHCP response packet over the network,
receiving a response in the form of a client request for an IP address from one or more such IP-unaddressed devices, and
by said broadcasting and receiving, discovering the presence of yet IP-unaddressed devices connected to the network.

8. A method employable in a computer-based network for discovering client devices connected to the network comprising
broadcasting over the network a gratuitous and unsolicited response to an imaginary client device request to a network server for server attention,
by said broadcasting, eliciting responses from yet undiscovered client devices which are connected to the network, and
by the combination of said broadcasting and eliciting-of-responses activities, discovering theretofore undiscovered network-connected client devices.

9. Apparatus in a computer-based IP network of the type which is without any DHCP/BootP server, for nonetheless employing the DHCP protocol to discover a yet IP-unaddressed device connected to the network, and to configure such a device with an assigned IP address, said apparatus comprising
a host device connected to the network and including
(a) first structure operable to place into a currently active status a DHCP protocol, and to broadcast over the network an unsolicited DHCP response packet,
(b) second structure constructed to receive and report in a device list return responses received, on account of such a broadcast, from one or more such IP-unaddressed devices,
(c) third structure operatively associated with said second structure, enabling user selection, from the device-list report created by said second structure, a particular IP-unaddressed device to configure with an assigned IP address, and
(d) fourth structure operatively associated with said third structure, operable to effect such assigning and configuring activities.

10. The apparatus of claim 9, wherein said host device further includes fifth structure operatively associated with said fourth structure, and constructed in relation to the assigning and configuring activities performed by said fourth structure, to disable the current operating status of the DHCP protocol, at least with respect to any previously IP-unaddressed device which has been effectively configured by operation of said fourth structure.
